(19) United States
(12) Patent Application Publication
(10) Pub. No.: US 2018/0027174 A1
(43) Pub. Date: Jan. 25, 2018

(54) SIGNALING CAMERA CONFIGURATION CHANGES USING METADATA DEFINED FOR A CAMERA COMMAND SET

(71) Applicant: QUALCOMM Incorporated, San Diego, CA (US)

(72) Inventor: Shoichiro Sengoku, San Diego, CA (US)

(21) Appl. No.: 15/214,308

(22) Filed: Jul. 19, 2016

(51) Int. Cl. H04N 5/232; G06F 13/40; G06F 13/36; G06F 13/42; H04N 5/235; G06F 3/0484

(52) U.S. Cl. CPC H04N 5/23216; H04N 5/23225; H04N 5/2353; G06F 3/04847; G06F 13/36; G06F 13/4282; G06F 13/40

(57) ABSTRACT

Systems, methods, and apparatus for signaling reconfiguration of an imaging device are disclosed. In one example, configuration changes in an imaging device are signaled by reconfiguring an operation of the imaging device, generating a first data frame after reconfiguring the operation of the imaging device, where the first data frame includes image data and embedded metadata associated with the image data, modifying the embedded metadata when the first data frame is the first-generated data frame generated after reconfiguring the operation of the imaging device, including modifying an element of the metadata that is associated with a feature of the imaging device unaffected by the reconfiguring, and transmitting the first data frame over an image data communication link after modifying the embedded metadata.

### TECHNICAL FIELD

The present disclosure relates generally to communication links connecting integrated circuit devices within an apparatus, and more particularly, to embedding signaling in metadata associated with frames of image data transmitted by a camera.

### BACKGROUND

Serial interfaces have become the preferred method for digital communication between integrated circuit (IC) devices in various apparatus, and multiple standards are defined for interconnecting certain components of the mobile devices. For example, mobile communications equipment may perform certain functions and provide capabilities using IC devices that include radio frequency (RF) transceivers, cameras, display systems, user interfaces, controllers, storage, and the like. For example, communication interfaces are defined for exchanging data and control information between an application processor and display and camera components of a mobile device. Some components employ an interface that conforms to one or more standards specified by the Mobile Industry Processor Interface (MIPI) Alliance. For example, the MIPI Alliance defines protocols for a camera serial interface (CSI) and a display serial interface (DSI). General-purpose serial interfaces may be used for communicating control and status information. The serial control interfaces may include the Inter-Integrated Circuit (I2C or FC) serial bus and its derivatives and alternatives, including interfaces defined by the MIPI Alliance, such as the I3C interface and the camera control interface (CCI).

In one example, an apparatus that includes a camera, image data may be transmitted over a high-speed unidirectional bus, while control information is exchanged over a bidirectional, low-speed serial control interface. In this example, command and control information exchanged over the serial control interface may have no direct temporal relationship to image data transmitted by the camera. Synchronization implemented using existing bus protocols may result in high-latencies and/or high degrees of uncertainty. As the demand for improved communications between devices continues to increase, there exists a need for improvements in signaling between application processors and peripheral devices, including cameras, that transmit high-speed data.

### SUMMARY

Certain aspects of the disclosure relate to systems, apparatus, methods and techniques for implementing and managing digital communication interfaces that may be used between IC devices in various apparatus. In one aspect, a camera device may signal a change in configuration that affects encoded image data by modifying metadata embedded in data frames carrying the image data. In some aspects, the digital communication interfaces provide multi-wire communication links between the IC devices. In one example, a multi-wire communication link may transport serialized data on one or more wires of a communication link. In some examples, a clock signal may be provided on a wire of the communication link to enable a receiver to decode data transmitted on one or more other wires of the communication link. In other examples, clock information is embedded in the encoded data transmitted on the communication link.

In various aspects of the disclosure, a method for signaling configuration changes in an imaging device includes reconfiguring an operation of the imaging device, generating a first data frame after reconfiguring the operation of the imaging device, where the first data frame includes image data and embedded metadata associated with the image data, modifying the embedded metadata when the first data frame is the first-generated data frame generated after reconfiguring the operation of the imaging device, including modifying an element of the metadata that is associated with a feature of the imaging device unaffected by the reconfiguring, and transmitting the first data frame over an image data communication link after modifying the embedded metadata.

In one aspect, the method includes reconfiguring the operation of the imaging device includes receiving a configuration command from a control data bus, and reconfiguring the operation of the imaging device in response to the configuration command.

In one aspect, the method includes modifying the embedded metadata includes storing a preconfigured signal value in a parameter of the metadata. Modifying the embedded metadata may include calculating a signal value based on current content of a parameter in the metadata, and storing the signal value as the parameter in the metadata.

In one aspect, the method includes modifying the embedded metadata includes storing a signal value in an unused parameter in the embedded metadata.

In one aspect, the content of the embedded metadata is defined by a camera command set specification. Modifying the embedded metadata may include storing a signal value in a parameter in the embedded metadata that is undefined by the camera command set specification. Modifying the embedded metadata may include storing a signal value in a parameter in the embedded metadata related to flash control or fine integration time.

In one aspect, the method includes generating a second data frame for transmission after the first data frame. Modifications to the embedded metadata transmitted with the first data frame may be reversed in metadata transmitted with the second data frame.

In one example, the image data communication link includes one or more lanes that carry a differentially-encoded data signal and a clock lane that carries a differentially encoded clock signal. In another example, data is encoded in symbols transmitted on the image data communication link, each symbol defining signaling state of a three-phase signal that is transmitted in different phases on each wire of a three-wire link, and wherein clock information is encoded in transitions between the symbols transmitted on the image data communication link.

In various aspects of the disclosure, an apparatus may have means for reconfiguring an operation of the imaging device, means for generating a first data frame after reconfiguring the operation of the imaging device, where the first data frame includes image data and embedded metadata associated with the image data, means for modifying the embedded metadata when the first data frame is the first-generated data frame generated after reconfiguring the operation of the imaging device and configured to modify an element of the metadata that is associated with a feature of the imaging device unaffected by the reconfiguring, and means for transmitting the first data frame over an image data communication link after modifying the embedded metadata.

In various aspects of the disclosure, a processor readable storage medium is disclosed. The storage medium may be a non-transitory storage medium and may store code that, when executed by one or more processors, causes the one or more processors to reconfigure an operation of the imaging device, generate a first data frame after reconfiguring the operation of the imaging device, where the first data frame includes image data and embedded metadata associated with the image data, modify the embedded metadata when the first data frame is the first-generated data frame generated after reconfiguring the operation of the imaging device by modifying an element of the metadata that is associated with a feature of the imaging device unaffected by the reconfiguring, and transmit the first data frame over an image data communication link after modifying the embedded metadata.

In various aspects of the disclosure, a method for detecting configuration changes in an imaging device includes receiving a first data frame from an image data communication link, the first data frame includes image data and embedded metadata associated with the image data, determining that a reconfiguration of the imaging device has occurred when a signal parameter in the embedded metadata has been modified, and decoding the image data in the first data frame in accordance with the reconfiguration of the imaging device. The signal parameter may be included in an element of the metadata that is associated with a feature of the imaging device unaffected by the reconfiguration of the imaging device.

### BRIEF DESCRIPTION OF THE DRAWINGS

FIG. 1 illustrates an apparatus that includes a high-speed bus that may be adapted in accordance with certain aspects disclosed herein.

FIG. 2 illustrates a first configuration in which a high-speed data bus and a low-speed serial control bus deployed between a system-on-chip (SoC) and a camera in a manner that may be adapted in accordance with certain aspects disclosed herein.

FIG. 3 illustrates a second configuration in which a high-speed data bus and a low-speed serial control bus deployed between an application processor and an imaging device in a manner that may be adapted in accordance with certain aspects disclosed herein.

FIG. 4 illustrates a D-PHY interface used to implement a high-speed data bus in accordance with certain aspects disclosed herein.

FIG. 5 illustrates a C-PHY interface used to implement a high-speed data bus in accordance with certain aspects disclosed herein.

FIG. 6 illustrates a serial control bus based on I2C deployed in accordance with certain aspects disclosed herein.

FIG. 7 illustrates a first view of a CSI-2 frame format that may be adapted in accordance with certain aspects disclosed herein.

FIG. 8 illustrates a second view of the CSI-2 frame format that may be adapted in accordance with certain aspects disclosed herein.

FIG. 9 illustrates a configuration change in a system that may be adapted in accordance with certain aspects disclosed herein.

FIG. 10 illustrates signaling of a configuration change in metadata according to certain aspects disclosed herein.

FIG. 11 is a block diagram illustrating an example of an apparatus employing a processing circuit that may be adapted according to certain aspects disclosed herein.

FIG. 12 is a flow chart of a method related to signaling using metadata defined for a camera command set in accordance with certain aspects disclosed herein.

FIG. 13 is a diagram illustrating an example of a hardware implementation for a host processing circuit adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

A host processor may transmit one or more commands that cause a change in camera configuration that is reflected in frames of image data received from the camera or imaging device. The first frame of imaging data reflecting the changed configuration may be identified by changes made to metadata that is defined for uses related to other configuration and control purposes.

In one example, an image sensor may be configured to embed configuration update information as code words or other parameters in metadata transmitted with image frames. The metadata may be transmitted as parameters defined in the Camera Command Set (CCS) specified by the MIPI Alliance. In one example, metadata may be used to signal that the corresponding data frame was processed after a reconfiguration has been executed in response to a configuration command, such that the corresponding changes to camera configuration have been implemented and are reflected in the image data in the data frame. The metadata used to signal changed configuration may include elements and/or parameters otherwise used to communicate certain information that is not applicable or related to image processing at the time the configuration update information is available for transmission. Configuration update information may be transmitted in fields of the metadata that have minimal or no effect on image processing. In another example, signaling may be accomplished by modulating an element of the metadata, whereby the element of data is changed for the data frame that has been processed according to a new configuration.

Example of Camera-Equipped Apparatus

Certain aspects of the invention may be applicable to communication links deployed between electronic devices that include subcomponents of an apparatus such as a telephone, a mobile computing device, an appliance, automobile electronics, avionics systems, etc. For example, an apparatus equipped with a camera may include a mobile computing device, a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, avionics systems, a wearable computing device (e.g., a smart watch, a health or fitness tracker, eyewear, etc.), an appliance, a sensor, a security device, a vending machine, a smart meter, a drone, a multicopter, or any other similar functioning device.

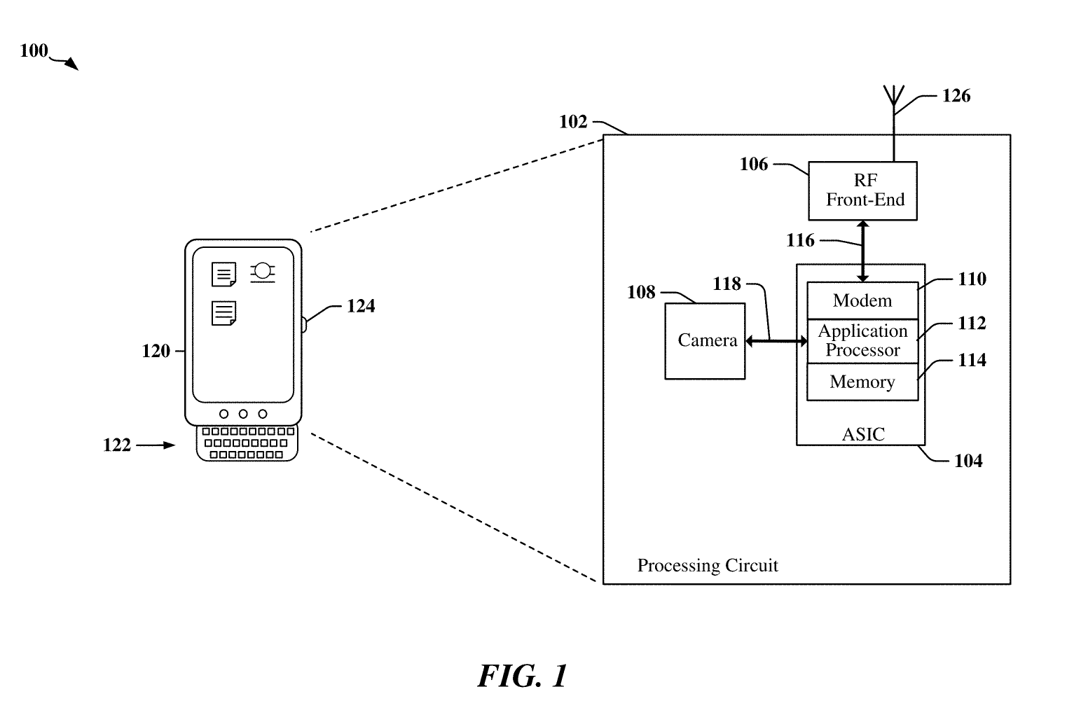

FIG. 1 depicts a camera-equipped apparatus 100 that may employ a communication link between IC devices. In one example, the apparatus 100 may be a mobile communication device. The apparatus 100 may include a processing circuit having two or more IC devices 104, 106, 108 that may be coupled using interfaces 116, 118 that include a high-speed communication link. One IC device 106 may be an RF front-end device 106 that enables the apparatus to communicate through one or more antennas 126 with a radio access network, a core access network, the Internet and/or another network. Another IC device 108 may provide an imaging interface and/or may be embodied in a camera.

The processing circuit 102 may comprise a SoC and/or may include one or more application-specific IC (ASIC) devices 104. In one example, an ASIC device 104 may include one or more application processors 112, logic circuits, modems 110, and processor readable storage such as a memory device 114. In one example, the memory device 114 may maintain instructions and data that may be executed by a processing device on the processing circuit 102. The processing circuit 102 may be controlled by one or more of an operating system and an application programming interface (API) layer that supports and enables execution of software modules residing in storage media. The memory device 114 may include read-only memory (ROM) or random-access memory (RAM), electrically erasable programmable ROM (EEPROM), flash cards, or any memory device that can be used in processing systems and computing platforms. The processing circuit 102 may include or have access to a local database or parameter storage that can maintain operational parameters and other information used to configure and operate apparatus 100. The local database may be implemented using one or more of a database module, flash memory, magnetic media, EEPROM, optical media, tape, soft or hard disk, or the like. The processing circuit may also be operably coupled to external devices such as the antennas 126, a display 120, operator controls, such as a button 124 and/or an integrated or external keypad 122, among other components.

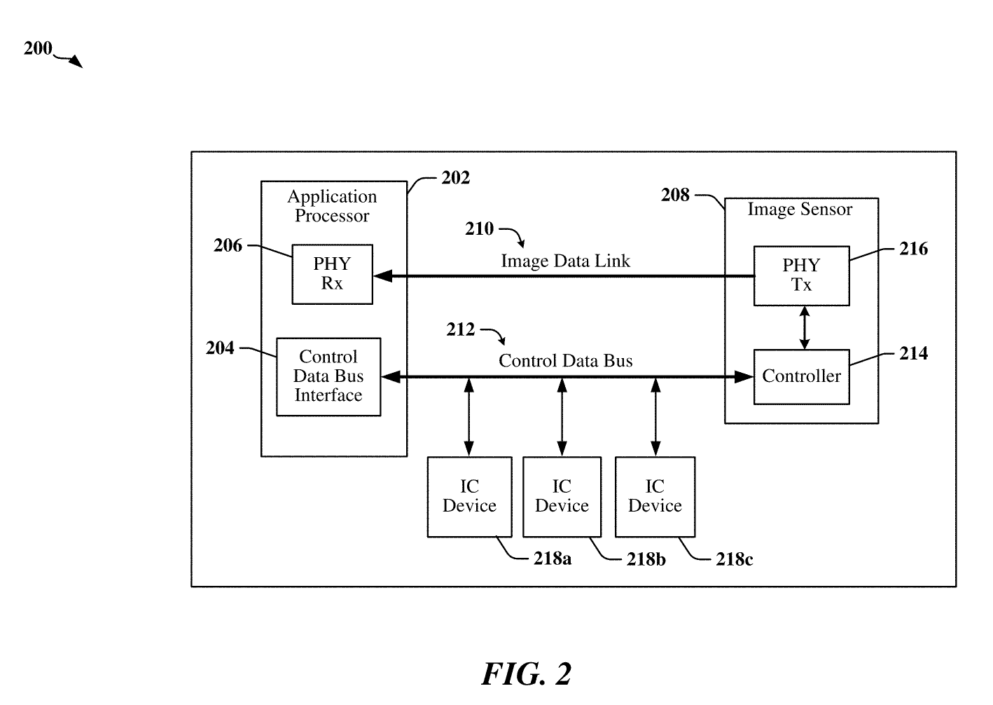

FIG. 2 illustrates an example of a system 200 that includes communication links 210, 212 used to couple an application processor 202 with an image sensor 208, camera or other imaging device. In one example, the system may be embodied in an SoC. The image sensor 208 may produce large volumes of pixel data and other data representative of an image captured by the image sensor. Data may be transmitted by the image sensor 208 in bursts when the image sensor 208 is capturing individual images or frames, and/or in continuous flow when the image sensor 208 is operated in a video mode or a multi-image mode. A control data bus interface 204 in the application processor 202 may transmit commands and receive responses to the commands that amount to a fraction of the image data transmitted when the image sensor 208 is active. In certain implementations, a unidirectional high-speed image data link 210 is provided to communicate image data from the image sensor 208 to the application processor 202. The application processor 202 may include a bus interface circuits (PHY Rx 206) that are configured to receive data from the image data link 210. Bus interface circuits (PHY Tx 216) in the image sensor 208 may enable the image sensor 208 to communicate over the image data link 210.

A low-speed bidirectional control data bus 212 may be provided to support communication of command and control information between the application processor 202 and the image sensor 208. The image sensor 208 may include a controller 214 that may be configured by the application processor 202. The controller 214 may control certain aspects of the operation of the image sensor 208. The control data bus 212 may couple other peripheral devices 218a, 218b, 218c to the application processor 202 and/or the controller of the image sensor 208. Protocols and specifications governing the high-speed image data bus 210 and the control data bus 212 may be defined by the MIPI Alliance, by another standards body, or by a system designer. For the purposes of this disclosure, an architecture based on the CSI-2 standards defined by the MIPI Alliance will be used as an example.

Examples of Interfaces Coupling Devices in a Communication Device

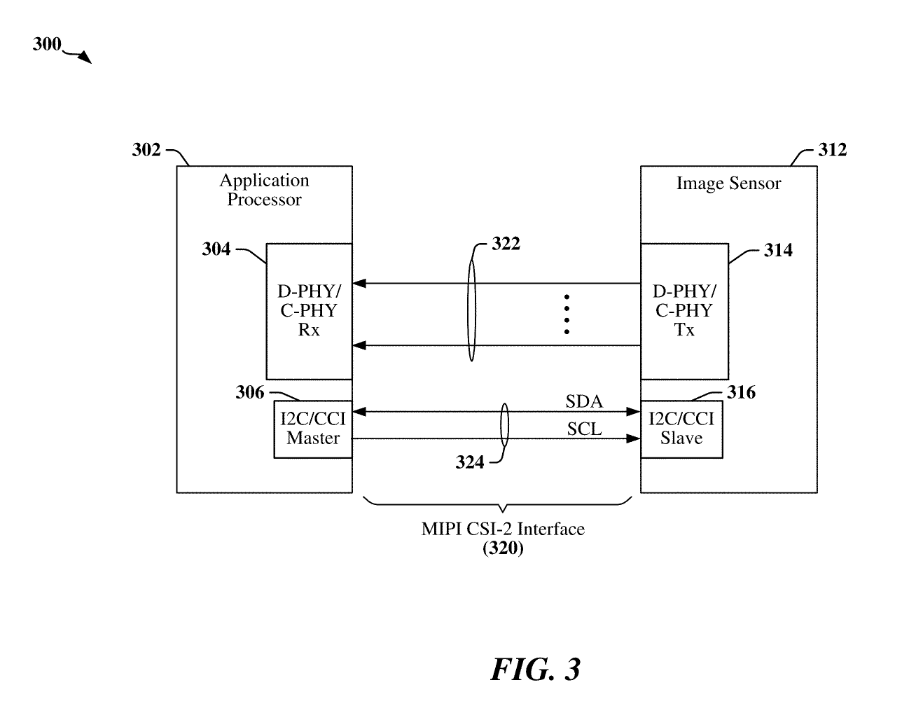

FIG. 3 illustrates an apparatus 300 that includes an application processor 302 and an image sensor 312 coupled by a CSI-2 interface 320. The CSI-2 interface 320 provides a multi-wire, high-speed data link 322 used by the image sensor 312 to transmit image data to the application processor 302. The high-speed data link 322 may be operated according to the C-PHY or D-PHY specifications or protocols defined by the MIPI Alliance. A transmitter 314 in the image sensor 312 may be adapted or configured to encode data for transmission over the high-speed data link 322. The CSI-2 interface 320 may include a control data bus 324 operated according to CCI or I2C protocols. The control data bus 324 may include a serial clock line (SCL) that carries a clock signal and a Serial Data line (SDA) that carries a data signal. The control data bus 324 may be bidirectional and may operate at a lower data rate than the high-speed data link 322. The control data bus 324 may be used by the application processor 302 to transmit control information and data to the image sensor 312 and to receive control and configuration information from the image sensor 312. The application processor 302 may include an I2C and/or CCI bus master 306 and the image sensor 312 may include a I2C and/or CCI bus slave 316. At the image sensor 312, a receiver circuit or module 304 may be configured to decode data in accordance with C-PHY or D-PHY protocols.

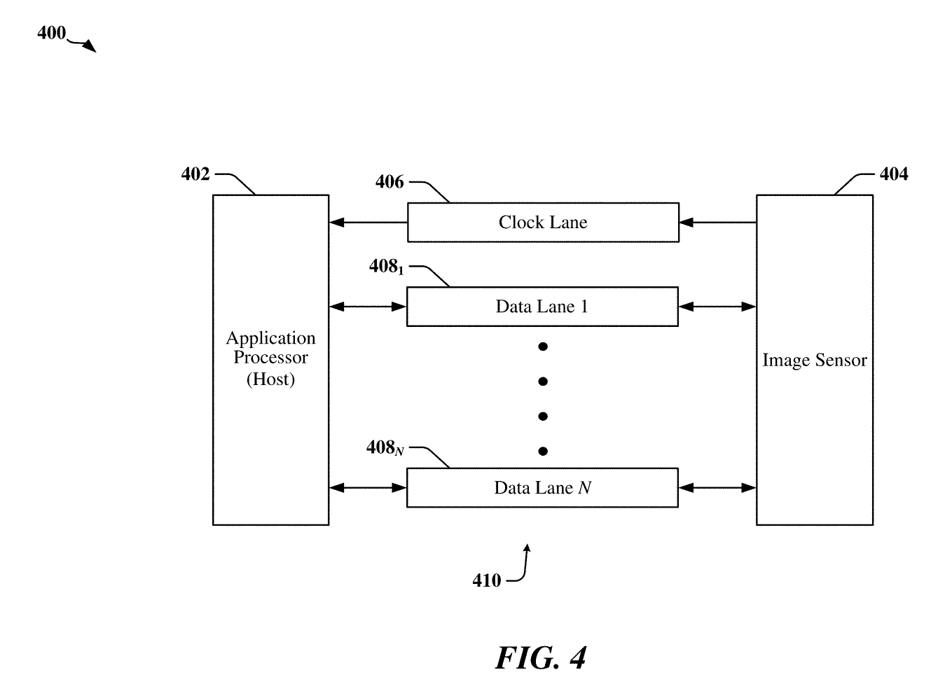

FIG. 4 illustrates a D-PHY interface 400 that may be operated in accordance with specifications or protocols defined by the MIPI Alliance. The MIPI Alliance-defined D-PHY physical layer interface technology may employ some combination of differential and single-ended encoding for communicating between devices 402 and 404. In some examples, the D-PHY physical layer can switch between a differential (High-speed) mode and a single-ended (Low Power) mode for transmitting data signals on each of a plurality of data lanes 408₁-408_{N}. Switching between modes can be accomplished in real time and as needed to facilitate the transfer of large amounts of data or to conserve power and prolong battery life. The D-PHY interface 400 is capable of operating in simplex or duplex configuration with one or more data lanes 408₁-408_{N} and a unidirectional clock lane 406 from the image sensor 404 to the application processor 402.

The D-PHY interface 400 may be used to connect a host device, such as an application processor 402 and a peripheral device such as an image sensor 404. The image sensor 404 generates a clock signal that controls data transmissions on the data lanes 408₁-408_{N}, where the clock signal is transmitted on the clock lane 406. The number of data lanes 408₁-408_{N} provided or active in a device may be dynamically configured based on application needs, volumes of data to be transferred and power conservation requirements.

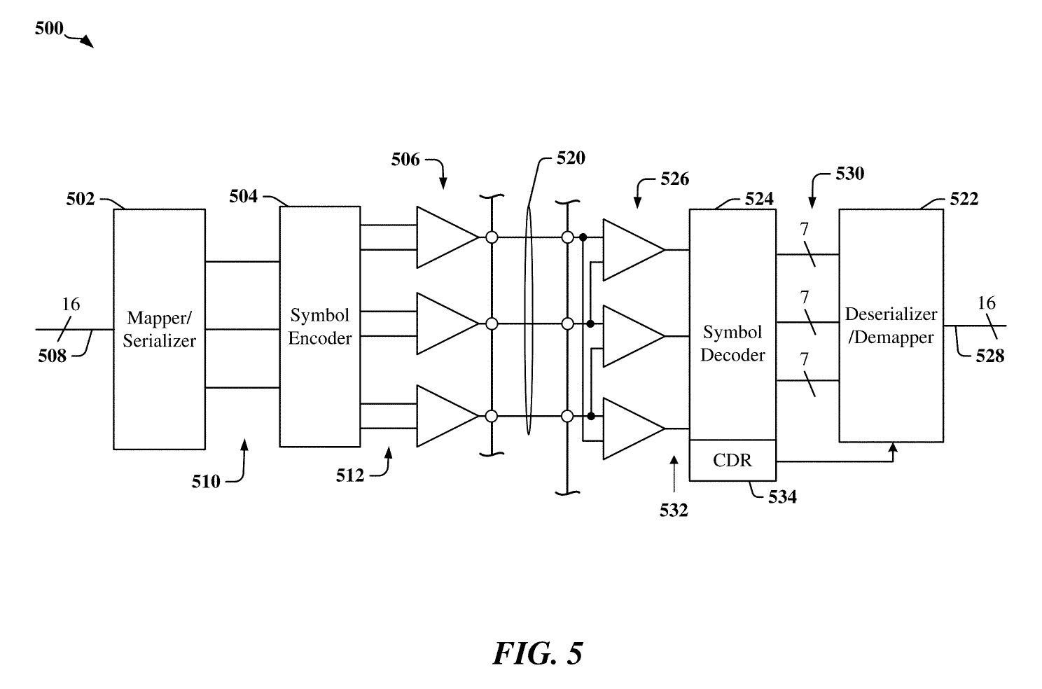

FIG. 5 illustrates a C-PHY interface 500 that may be operated in accordance with specifications or protocols defined by the MIPI Alliance. The MIPI Alliance-defined C-PHY physical layer interface technology uses 3-phase polarity encoding. The illustrated C-PHY interface 500 uses a three-wire link 520. At the transmitter, physical layer drivers 506 may each drive a wire of a three-wire link 520. Data is encoded in a sequence of symbols transmitted on the three-wire link 520, where each symbol defines signaling state of the three-wire link 520 for one symbol interval. In each symbol interval, one wire of the three-wire link 520 is undriven and the other two wires of the three-wire link 520 are driven with opposite polarity. C-PHY interface 500 can provide for high-speed data transfer and may consume half or less of the power of other interfaces because fewer than 3 drivers are active in each symbol interval.

In the illustrated C-PHY interface 500, each wire of the 3-wire link 520 may be undriven, driven positive, or driven negative. An undriven signal wire may be in a high-impedance state. An undriven signal wire may be driven or pulled to a voltage level that lies substantially halfway between the positive and negative voltage levels provided on driven signal wires. An undriven signal wire may have no current flowing through it. The signaling states may be denoted as {+1, −1, 0}, and the line drivers 506 may be adapted to provide each of the three signaling states. In one example, drivers 506 may include unit-level current-mode drivers. In another example, drivers 506 may drive opposite polarity voltages on two signals transmitted on two wires of the three-wire link 520 while the third wire is at high impedance and/or pulled to ground. For each symbol interval, at least one signal is in the undriven (0) state, while the number of signals driven positive (+1 state) is equal to the number of signals driven negative (−1 state), such that the sum of current flowing to the receiver is always zero. For each symbol, the state of at least one signal wire is changed from the symbol transmitted in the preceding transmission interval.

The C-PHY interface 500 can encode multiple bits per transition on the three-wire link 520. In one example, a mapper/serializer 502 may map 16-bit data 508 to a set of seven 3-bit symbols which are provided in a serialized 3-bit sequence of raw symbols 510 to a symbol encoder 504. The symbol encoder 504 provides a sequence of control signals 512 corresponding to transmitted symbols that determine the signaling state of the three-wire link 520 for each of seven symbol intervals. The symbol encoder determines each transmitted symbol based on the immediately preceding transmitted symbol and a current raw symbol 510. The symbol encoder 504 operates such that, for each symbol interval, the signaling state of at least one wire of the three-wire link 520 changes with respect to the signaling state in the immediately preceding symbol interval.

The use of 3-wire, 3-phase encoding permits a number of bits to be encoded in a plurality of symbols where the bits per symbol is not an integer. In the simple example of a three-wire, three-phase system, there are 3 available combinations of 2 wires, which may be driven simultaneously, and 2 possible combinations of polarity on any pair of wires that is driven simultaneously, yielding 6 possible states. Since each transition occurs from a current state to a different state, 5 of the 6 states are available at every transition such that the signaling state of at least one wire changes at each transition. With 5 states, log₂(5)≅2.32 bits may be encoded per symbol. Accordingly, a mapper may accept a 16-bit word and convert it to 7 symbols, because 7 symbols carrying 2.32 bits per symbol can encode 16.24 bits. In other words, a combination of seven symbols that encodes five states has 5⁷ (78,125) permutations. Accordingly, the 7 symbols may be used to encode the 2¹⁶ (65,536) permutations of 16 bits.

At the receiver, a set of comparators 526 and symbol decoders 524 are configured to provide a digital representation of the state of each wire of the three-wire link 520. The symbol decoder 524 may include a clock and data recovery (CDR) circuit 534 that generates a clock signal using transitions detected in the state of the three-wire link 520 between successive symbol intervals, where the clock signal is used to capture symbol values that represent signaling state of the three-wire link 520. A deserializer/demapper 522 assembles a set of 7 symbols, which is demapped to obtain 16 bits of output data 528.

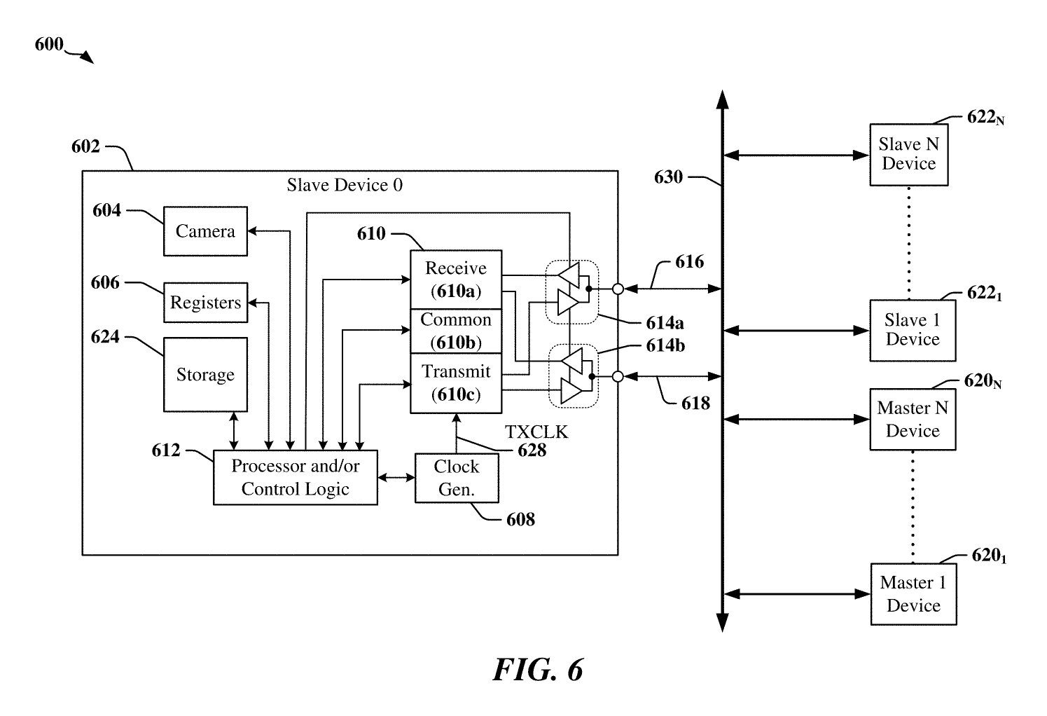

FIG. 6 illustrates an architecture 600 for a control data bus 630 that may be operated in accordance with I2C protocols or in accordance with a protocol based on or derived from the I2C protocols. For example, the control data bus 630 may be operated in accordance with CCI, I3C and other specifications or protocols defined by the MIPI Alliance. A control data bus 630 may be provided in a device that may be adapted according to certain aspects disclosed herein, and the control data bus 630 may couple a plurality of bus master devices 620₁-620_{N} and slave devices 602 and 622₁-622_{N}. The control data bus 630 may be configured according to application needs, and access to multiple buses 630 may be provided to certain of the devices 620₁-620_{N}, 602, and 622₁-622_{N}. In operation, one of the bus master devices 620₁-620_{N} may gain control of the bus and transmit a slave identifier or slave address to identify one of the slave devices 602 and 622₁-622_{N} to engage in a communication transaction. Bus master devices 620₁-620_{N} may read data and/or status from slave devices 602 and 622₁-622_{N}, and may write data to memory or may configure the slave devices 602 and 622₁-622_{N}. Configuration may involve writing to one or more registers or other storage on the slave devices 602 and 622₁-622_{N}.

In the example illustrated in FIG. 6, a first slave device 602 coupled to the control data bus 630 may respond to one or more bus master devices 620₁-620_{N}, which may read data from, or write data to the first slave device 602. In the first slave device 602 a camera function 604 may include circuits and modules includes control used to configure, manage and/or control the operation of an imaging device.

The first slave device 602 may include configuration registers 606 and/or other storage devices 624, a processing circuit and/or control logic 612, a transceiver 610 and a number of line driver/receiver circuits 614a, 614b as needed to couple the first slave device 602 to the control data bus 630. The processing circuit and/or control logic 612 may include a processor such as a state machine, sequencer, signal processor or general-purpose processor. The transceiver 610 may include one or more receivers 610a, one or more transmitters 610c and certain common circuits 610b, including timing, logic and storage circuits and/or devices. In some instances, the transceiver 610 may include encoders and decoders, clock and data recovery circuits, and the like. A transmit clock (TXCLK) signal 628 may be provided to the transmitter 610c, where the TXCLK signal 628 can be used to determine data transmission rates.

The control data bus 630 may be implemented as a serial bus in which data is converted from parallel to serial form by a transmitter, which transmits the encoded data as a serial bitstream. A receiver processes the received serial bitstream using a serial-to-parallel convertor to deserialize the data. The serial bus may include two or more wires, and a clock signal may be transmitted on one wire with serialized data being transmitted on one or more other wires. In some instances, data may be encoded in symbols, where each bit of a symbol controls the signaling state of a wire of the control data bus 630.

Metadata Transmitted with Image Data

A camera and/or other imaging device may be adapted to produce data representative of an image in a specified or desired format. The camera and/or other imaging device may be further adapted to respond to a command set that controls imaging operations, image processing, camera configuration and formats used to transport data from the camera to a host processor. For example, the CCS developed by the MIPI Alliance is a functional specification that defines camera module and camera sensor functionality. Certain benefits accrue from the use of the CCS, including an ability to define a standardized camera driver that is unaffected by camera device-level changes to electrical, control and image data interfaces. The CCS provides commands related to camera operating modes, device identification, data formats and data arrangements, as well as video timing, cropping and decimation modes. Other commands relate to integration time and gain control. Integration time, for example, is used to control exposure time by defining the number of complete sensor line periods to be integrated (coarse_integration_time parameter) or the additional number of sensor pixel periods to be integrated (fine_integration_time). Other commands define or control single-frame and multi-frame exposure modes, high definition, high dynamic range (HDR), phase detection autofocus (PDAF), sensor corrections and timer functionality. CCS may also define a data transfer interface between camera and host processor for calibration and other data, reporting camera module capabilities and key performances, and test modes.

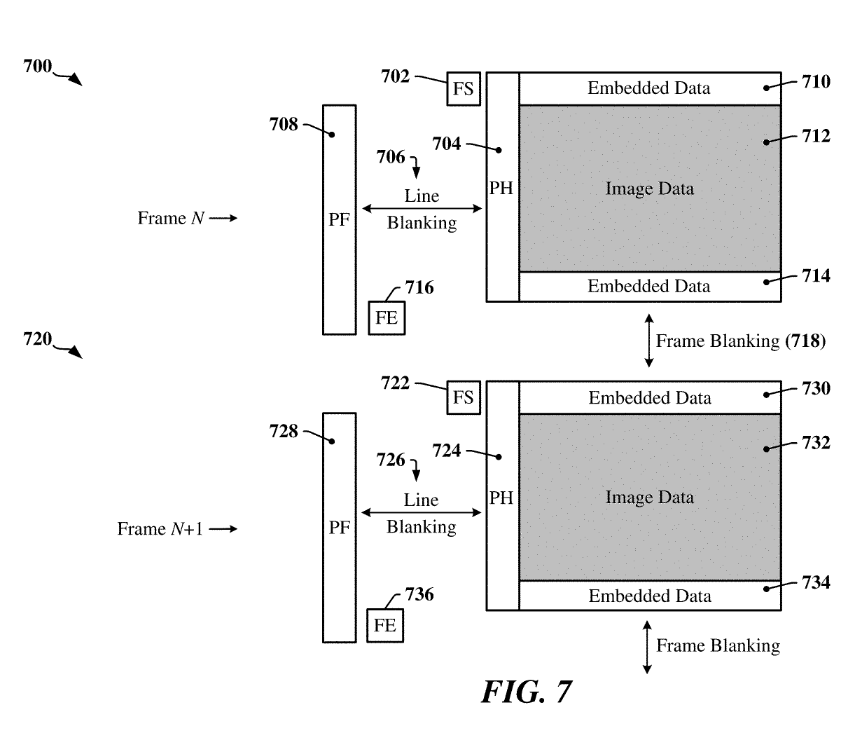

FIG. 7 illustrates certain aspects of CSI-2 formats for data frames 700, 720 transmitted by a camera. The data frames 700, 720 may each carry encoded data representative of an image captured by the camera. The first-transmitted data frame 700 includes image data 712 corresponding to a first-in-time captured image. Following a first delay referred to as a frame blanking period 718, a second-in-time captured image is represented in the image data 732 transmitted in the second-transmitted data frame 720. Each transmitted data frame 700, 720 accounts for a second delay referred to as a line blanking period 706, 726 between lines of the image. Blanking periods may be provided for compatibility with raster graphics display systems that define an image as a set of horizontal lines spanning the frame, with a horizontal blanking interval between successive lines and a vertical blanking interval between the end of the final line of a frame and the beginning of the first line of the next frame. In some instances, embedded data 710, 714, 730, 734 may include metadata that provides configuration and other information related to a current data frame 700, 720.

A frame start (FS) indication 702, 722 may be transmitted at the beginning of each data frame 700, 720. Each row of pixels (line) may be encoded in a packet that is preceded by a packet header 704, 724 and followed by a packet footer 708, 728. The first packet may include embedded data 710, including metadata for the image data 712, 732 in the current data frame 700, 720. One or more packets may be transmitted with embedded data before packets representing the image data 712, 732 are transmitted. After the image data 712, 732 has been transmitted, additional packets can optionally be transmitted to carry embedded data 714, 734. After the final packet has been transmitted, a frame end (FE) indication 716, 736 may be transmitted.

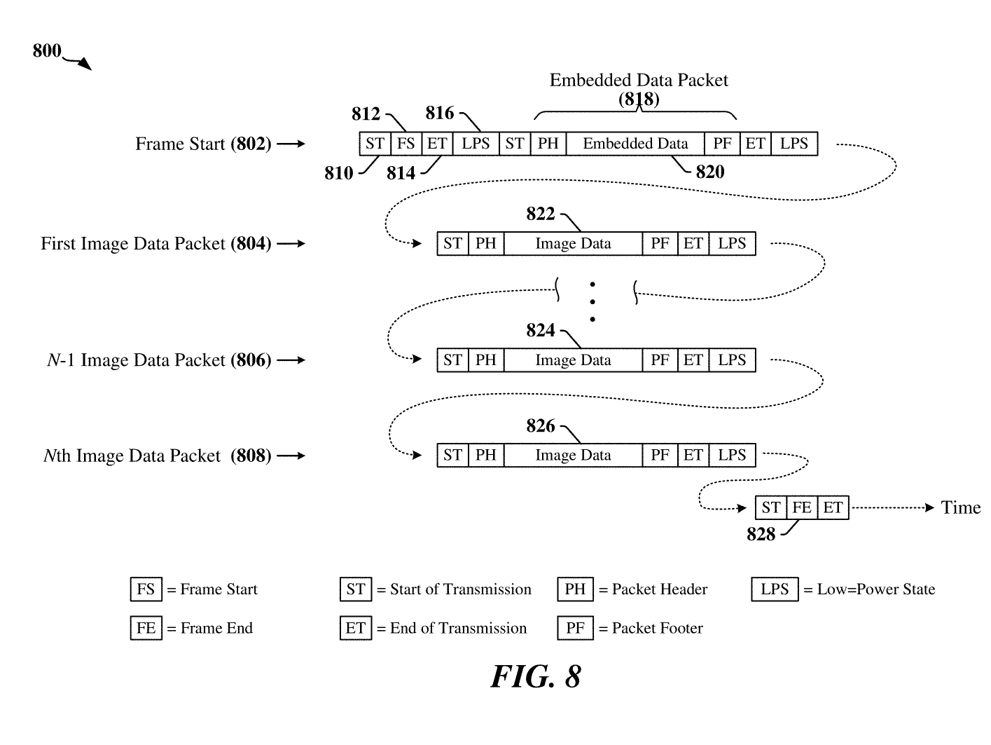

FIG. 8 illustrates a transmission 800 of a CSI-2 formatted data frame 700, 720 from a camera (see image sensor 208 of FIG. 2) to an application processor 202 or other host processor. The transmission 800 commences with a frame start packet 812. Each packet 812, 818, 804, 806, 808 may be preceded by start of transmission (SoT) and followed by an end of transmission (EoT). For example, the frame start packet 812 is preceded by a first SoT 810 and followed by a first EoT 814. A delay may follow during which the transmitter may enter a low-power state 816. After the delay, a first data packet is transmitted, where the first data packet may comprise an embedded data packet 818 wrapped with a SoT and EoT pair. In the example, the embedded data packet 818 is transmitted with a payload of embedded metadata 820 preceded by a packet header and followed by packet footer. After each packet has been transmitted, there may be a delay before the next packet is transmitted, during which the transmitter may enter a low-power state 816. After the embedded data packets 818 have been transmitted, image data packets 804, 806, 808 are transmitted with image data payloads 822, 824, 826. Multiple image data packets 804, 806, 808 may be sent (here, N data lines). After all of the image data packets 804, 806, 808 have been transmitted, one or more additional packets may optionally be transmitted with embedded data payloads. A frame end packet 828 may signal completion of the data frame 700, 720.

Configuration Change Latencies

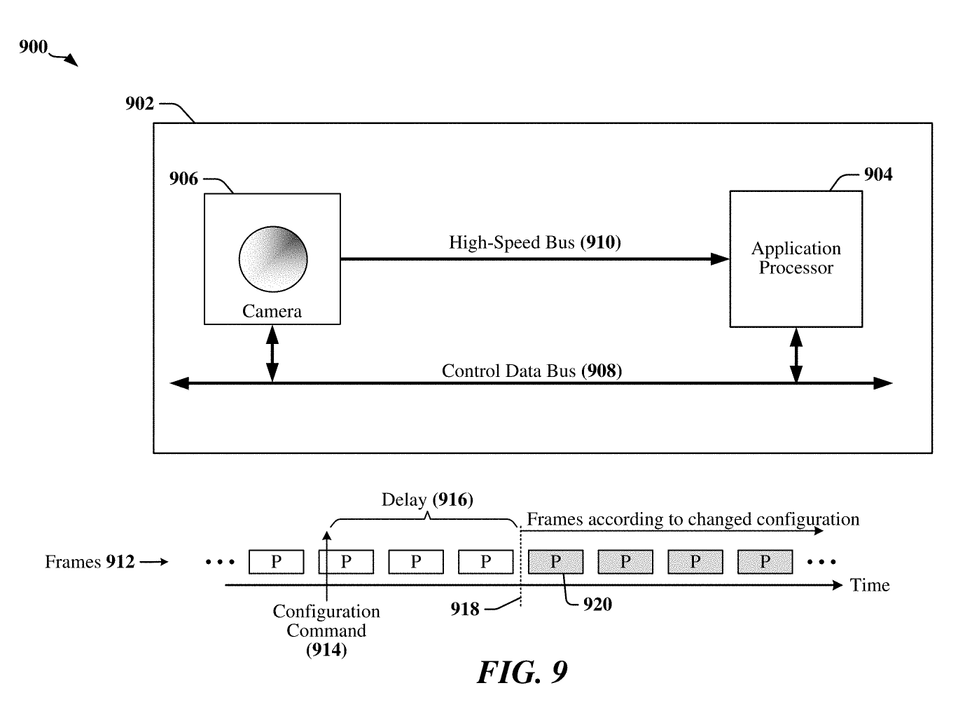

FIG. 9 is an example 900 illustrating certain effects of timing delays on image data. In the example 900, an apparatus 902 includes a high-speed bus 910 that may be used by a camera 906 to transmit image data to an application processor 904 or other host processing system or device. In one example, the high-speed bus 910 is operated in accordance with C-PHY protocols. In another example, the high-speed bus 910 is operated in accordance with D-PHY protocols. A control data bus 908 may provide a bidirectional interface between the camera 906 and the application processor 904. In one example, the control data bus 908 may be operated according to I2C protocols. In another example, the control data bus 908 may be operated according to CCI protocols. In another example, the control data bus 908 may be operated according to I3C protocols.

The control data bus 908 may be used by the application processor 904 to communicate commands to the camera 906 in order to configure the camera, effect a change in operating parameters, or otherwise cause a change in imaging sensor configuration that affects the format or encoding of data transmitted over the high-speed bus 910. In one example, a configuration command 914 may be transmitted to the camera 906 in order to modify an aperture setting, a shutter speed, zoom, focus, or another setting that affects the captured image and/or processing of the captured image. The application processor 904 or another receiver of image data from the camera 906 may need to modify image processing modules, circuits and algorithms after a reconfiguration of the camera 906. In many instances, a variable delay 916 occurs between receipt of a configuration command 914 at the camera 906 and transmission of a first modified frame 920 representing an image captured after reconfiguration of the camera 906. The application processor 904 may have limited options for determining that the first modified frame 920 is the first of a stream of frames 912 to reflect the effects of reconfiguration of the camera 906. The application processor 904 may be configured to determine when the new configuration is in use in the current frame by parsing parameters in the embedded line. Parsing by software components is typically slow and expensive if implemented in hardware, where special hardware mechanisms and software/hardware interfaces may be required to fully interpret embedded data and compare all the new configuration relate information. In conventional systems, parsing is avoided and a number of frames may be dropped after the configuration command 914 is transmitted, which can cause effects that are noticeable by a viewer of captured images. The system may drop as many frames as is necessary for the system to be certain that the new configuration has been propagated and is in effect. For example, many conventional systems may drop 10 frames, representing 0.33 seconds of video information.

Signaling Using Metadata

According to certain aspects disclosed herein, an image sensor may be configured to embed configuration update information as parameters, code words or other signals in metadata transmitted with image frames. The metadata may be formatted as provided in the CCS specified by the MIPI Alliance. In one example, metadata may be used to signal that the corresponding data frame 700, 720 was processed after a configuration command 914 has been executed and the corresponding changes to camera configuration have been implemented. The elements or parameters of the metadata used to signal changed configuration may be otherwise used to communicate certain other information that is not applicable or not used for image processing at the time the configuration update information is available for transmission. In another example, the configuration update information may be transmitted in fields of the metadata that have minimal or no effect on image processing. In another example, signaling may be accomplished by modulating an element of the metadata, whereby the element of data is changed in a predictable and reversible manner for the data frame 700, 720 that has been processed according to a new configuration.

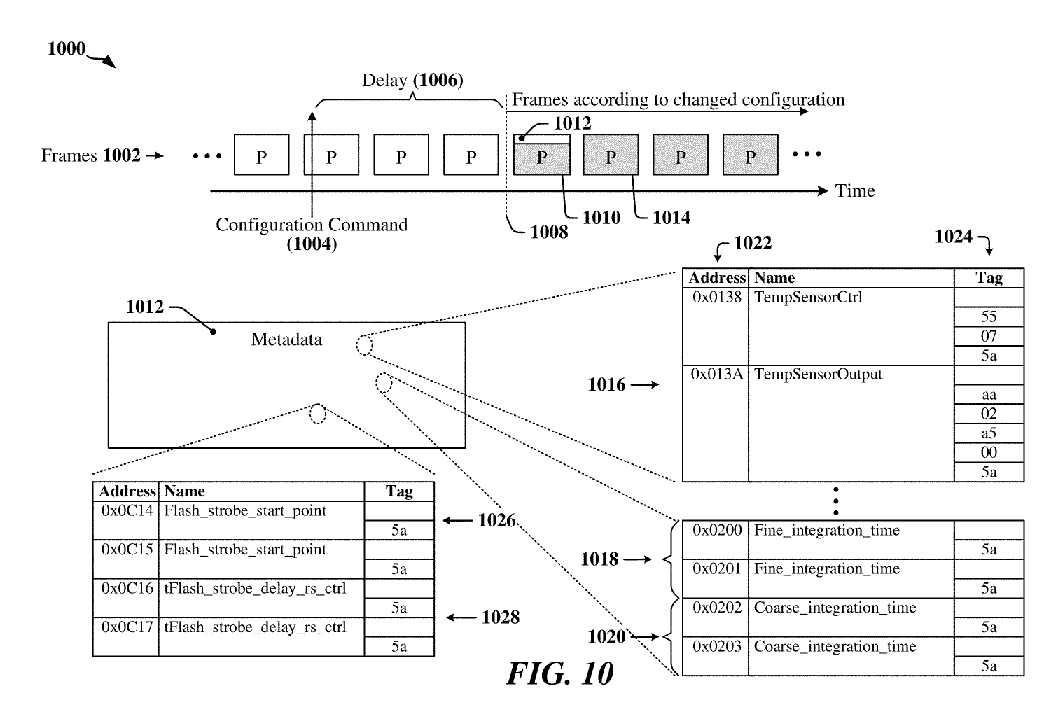

FIG. 10 illustrates an example in which a first-affected data frame 1010 is signaled by modification of one or more elements of metadata 1012 transmitted with the data frame 1010. According to certain aspects, the modified elements of metadata 1012 may be defined for use as a source of configuration or status information unrelated to changes in configuration of a camera 906 in response to a configuration command 1004 transmitted by an application processor 904 or other host processing system.

In one example, a configuration command 1004 may be transmitted to the camera 906 in order to modify an aperture setting, a shutter speed, zoom, focus, or another setting that affects the captured image and/or processing of the captured image. An indeterminate and/or variable delay 1006 may occur between receipt of the configuration command 1004 at the camera 906 and transmission of a first modified data frame 1010 representing an image captured after reconfiguration of the camera 906. The first modified data frame 1010 includes metadata 1012 in which a field or parameter has been modified or modulated in order to signal that the image data transmitted in the first modified data frame 1010 was generated using the new configuration. The application processor 904 may handle the image data in the first modified data frame 1010 in accordance with the new configuration of the camera 906.

The camera 906 may store a signal value in a selected element or parameter of metadata 1012 for the purpose of signaling that the associated data frame 1010 includes image data representing an image captured after reconfiguration of the camera 906, in response to the configuration command 1004 for example. An element or parameter of the metadata 1012 may be selected if the element or parameter is undefined by specifications (e.g., a reserved value), unused in the implemented system, and/or unused or inactive before, during and/or after the reconfiguration of the camera 906. An element or parameter of the metadata 1012 may be selected if changes to the element or parameter can be expected to have minimal effect on processing of image data received in the corresponding data frame 1010. The signal value may be any value that is recognizable by the application processor 904 or another recipient of the data frame 1010 as a modified value.

In one example, the signal value may be binary in nature such that a zero value stored in a parameter or element of the metadata 1012 may be distinguished from a non-zero value. A zero value, initially stored in an element or parameter that is undefined or unused, may be changed to a non-zero value to signal that the associated data frame 1010 is the first data frame generated using the new configuration. In this example, the parameter or element of the metadata 1012 may be restored to a zero value in the data frame 1014 that follows the first modified data frame 1010, and in later frames.

In another example, the signal value may be configured by a system or device designer or integrator. In this example, the signal value may be selected from values outside a range of possible values defined by device specifications for the modified element or parameter. In a first example, the selected parameter or element of the metadata 1012 may be specified as a non-zero value and the camera 906 may set the value of the selected parameter or element of the metadata 1012 to zero in order to indicate that the associated data frame 1010 is the first data frame generated using the new configuration. In a second example, the selected parameter or element of the metadata 1012 may be permitted by specification to have a value that lies with a range of possible values, and the camera 906 may set the value of the selected parameter or element of the metadata 1012 to a value outside the range of possible values in order to indicate that the associated data frame 1010 is the first data frame generated using the new configuration. In a third example, the selected parameter or element of the metadata 1012 may be permitted by specification to have a value that is zero or positive, and the camera 906 may set the value of the selected parameter or element of the metadata 1012 to a negative value to indicate that the associated data frame 1010 is the first data frame generated using the new configuration. In these examples, the parameter or element of the metadata 1012 may be restored to its original value in the data frame 1014 that follows the first modified data frame 1010, and in later frames.

In other examples, the signal value may be superimposed or otherwise modulated on a current value in the selected parameter or element of the metadata 1012. In a first example, the signal value may be a configured number known to the application processor 904 or another recipient of the data frame 1010 that the camera 906 adds to the current value in the selected parameter or element of the metadata 1012. In a second example, the signal value may be calculated by binary inversion of one or more bits in the selected parameter or element of the metadata 1012. In a third example, the signal value may be calculated by inverting the sign of the selected parameter or element of the metadata 1012. In these examples, the parameter or element of the metadata 1012 may be restored to its original value by the application processor 904 or another recipient of the data frame 1010, and in the data frame 1014 that follows the first modified data frame 1010, and in later frames.

The camera 906 may store a signal value in a selected element of metadata 1012, where the signal value is recognized by the application processor 904 during receipt of the data frame 1010. In some implementations, the application processor 904 may parse the metadata 1012 prior to, or concurrently with reception of image data packets in the data frame 1010, and the application processor 904 may then cause the image data to be processed in accordance with the changed configuration. The application processor 904 may read parameters at certain addresses of the metadata 1012. The addresses may, for example, index parameters using the byte location of the parameter from the beginning of the embedded data packet 818 (see FIG. 8) that carries the metadata.

FIG. 10 includes illustrations of examples of elements or parameters 1016, 1018, 1020, 1026, 1028 of the metadata 1012. In a first example, elements or parameters 1016 of the metadata 1012 related to a temperature sensor in the camera 906 are stored at the addresses 0x0138 and 0x13A (see address column 1022). These elements may include multiple parameters or bytes of data. Metadata may include different types of embedded data. In one example, data may be provided in tagged data packets, where the packet includes a tag 1024 that defines the meaning of following data in the packet. Embedded data may comprise a sequence of tagged data packets terminated by a data packet with a special tag signifying end of data. The second example, relates to single byte parameters of the metadata 1012 related to integration time for image data produced by the camera 906 are stored at the addresses 0x0200-0x0203.

In one example, a fine integration time parameter 1018 may be the parameter or element of the metadata 1012 received in a data frame from an image sensor that is selected for signaling the first modified data frame 1010. The CCS defines coarse integration time parameters 1020 and fine integration time parameters 1018 that may be used by the application processor 904 or another recipient of the data frame 1010 for integration time control during image processing. The fine integration time parameters 1018 are optional parameters, which may be unused in many camera systems. According to certain aspects, the camera 906 may store a signal value in one or more of the fine integration time parameters 1018 to indicate that the associated data frame 1010 is the first data frame generated using the new configuration, and/or that the data frame 1010 is generated under a changed image sensor configuration. In some instances, the least significant bits of a fine integration time parameter 1018 may be used. In some instances, the signal value may be transmitted in the least significant bits of the fine integration time parameter or parameters without significantly affecting image processing.

In another example, the metadata 1012 includes parameters related to operation or use of a flash. If the flash is not in use (e.g., when the image sensor is operated in video mode), then one or more parameters may be used to carry configuration update information. When the flash is inactive, one or more of the flash parameters may be selected for signaling the associated data frame 1010 is the first data frame generated using the new configuration, and/or that the data frame 1010 is generated under a changed image sensor configuration. Examples of such flash-related parameters include the flash_strobe_start_point parameters 1026 located at addresses 0x0C14 and 0x0C15, the tFlash_delay_rs_ctrl parameters 1028 located at addresses 0x0C16 and 0x0C17, and the tFlash_strobe_width_high_rs_ctrl parameters (not shown).

Examples of Processing Circuits and Methods

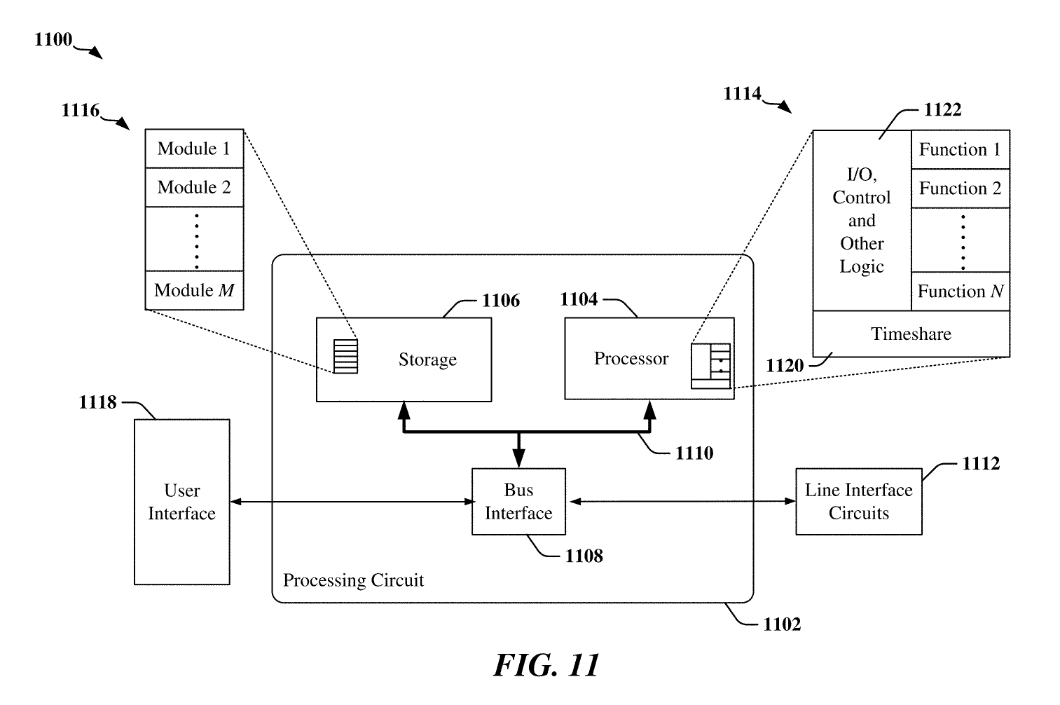

FIG. 11 is a conceptual diagram illustrating a simplified example of a hardware implementation for an apparatus 1100 employing a processing circuit 1102 that may be configured to perform one or more functions disclosed herein. In accordance with various aspects of the disclosure, an element, or any portion of an element, or any combination of elements as disclosed herein may be implemented using the processing circuit 1102. The processing circuit 1102 may include one or more processors 1104 that are controlled by some combination of hardware and software modules. Examples of processors 1104 include microprocessors, microcontrollers, digital signal processors (DSPs). ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1104 may include specialized processors that perform specific functions, and that may be configured, augmented or controlled by one of the software modules 1116. The one or more processors 1104 may be configured through a combination of software modules 1116 loaded during initialization, and further configured by loading or unloading one or more software modules 1116 during operation.

In the illustrated example, the processing circuit 1102 may be implemented with a bus architecture, represented generally by the bus 1110. The bus 1110 may include any number of interconnecting buses and bridges depending on the specific application of the processing circuit 1102 and the overall design constraints. The bus 1110 links together various circuits including the one or more processors 1104, and storage 1106. Storage 1106 may include memory devices and mass storage devices, and may be referred to herein as computer-readable media and/or processor-readable media. The bus 1110 may also link various other circuits such as timing sources, timers, peripherals, voltage regulators, and power management circuits. A bus interface 1108 may provide an interface between the bus 1110 and one or more transceivers 1112. A transceiver 1112 may be provided for each networking technology supported by the processing circuit. In some instances, multiple networking technologies may share some or all of the circuitry or processing modules found in a transceiver 1112. Each transceiver 1112 provides a means for communicating with various other apparatus over a transmission medium. Depending upon the nature of the apparatus 1100, a user interface 1118 (e.g., keypad, display, speaker, microphone, joystick) may also be provided, and may be communicatively coupled to the bus 1110 directly or through the bus interface 1108.

A processor 1104 may be responsible for managing the bus 1110 and for general processing that may include the execution of software stored in a computer-readable medium that may include the storage 1106. In this respect, the processing circuit 1102, including the processor 1104, may be used to implement any of the methods, functions and techniques disclosed herein. The storage 1106 may be used for storing data that is manipulated by the processor 1104 when executing software, and the software may be configured to implement any one of the methods disclosed herein.

One or more processors 1104 in the processing circuit 1102 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1106 or in an external computer-readable medium. The external computer-readable medium and/or storage 1106 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 1106 may also include, by way of example, a carrier wave, a transmission line, and any other suitable medium for transmitting software and/or instructions that may be accessed and read by a computer. Computer-readable medium and/or the storage 1106 may reside in the processing circuit 1102, in the processor 1104, external to the processing circuit 1102, or be distributed across multiple entities including the processing circuit 1102. The computer-readable medium and/or storage 1106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1106 may maintain software maintained and/or organized in loadable code segments, modules, applications, programs, etc., which may be referred to herein as software modules 1116. Each of the software modules 1116 may include instructions and data that, when installed or loaded on the processing circuit 1102 and executed by the one or more processors 1104, contribute to a run-time image 1114 that controls the operation of the one or more processors 1104. When executed, certain instructions may cause the processing circuit 1102 to perform functions in accordance with certain methods, algorithms and processes described herein.

Some of the software modules 1116 may be loaded during initialization of the processing circuit 1102, and these software modules 1116 may configure the processing circuit 1102 to enable performance of the various functions disclosed herein. For example, some software modules 1116 may configure internal devices and/or logic circuits 1122 of the processor 1104, and may manage access to external devices such as the transceiver 1112, the bus interface 1108, the user interface 1118, timers, mathematical coprocessors, and so on. The software modules 1116 may include a control program and/or an operating system that interacts with interrupt handlers and device drivers, and that controls access to various resources provided by the processing circuit 1102. The resources may include memory, processing time, access to the transceiver 1112, the user interface 1118, and so on.

One or more processors 1104 of the processing circuit 1102 may be multifunctional, whereby some of the software modules 1116 are loaded and configured to perform different functions or different instances of the same function. The one or more processors 1104 may additionally be adapted to manage background tasks initiated in response to inputs from the user interface 1118, the transceiver 1112, and device drivers, for example. To support the performance of multiple functions, the one or more processors 1104 may be configured to provide a multitasking environment, whereby each of a plurality of functions is implemented as a set of tasks serviced by the one or more processors 1104 as needed or desired. In one example, the multitasking environment may be implemented using a timesharing program 1120 that passes control of a processor 1104 between different tasks, whereby each task returns control of the one or more processors 1104 to the timesharing program 1120 upon completion of any outstanding operations and/or in response to an input such as an interrupt. When a task has control of the one or more processors 1104, the processing circuit is effectively specialized for the purposes addressed by the function associated with the controlling task. The timesharing program 1120 may include an operating system, a main loop that transfers control on a round-robin basis, a function that allocates control of the one or more processors 1104 in accordance with a prioritization of the functions, and/or an interrupt driven main loop that responds to external events by providing control of the one or more processors 1104 to a handling function.

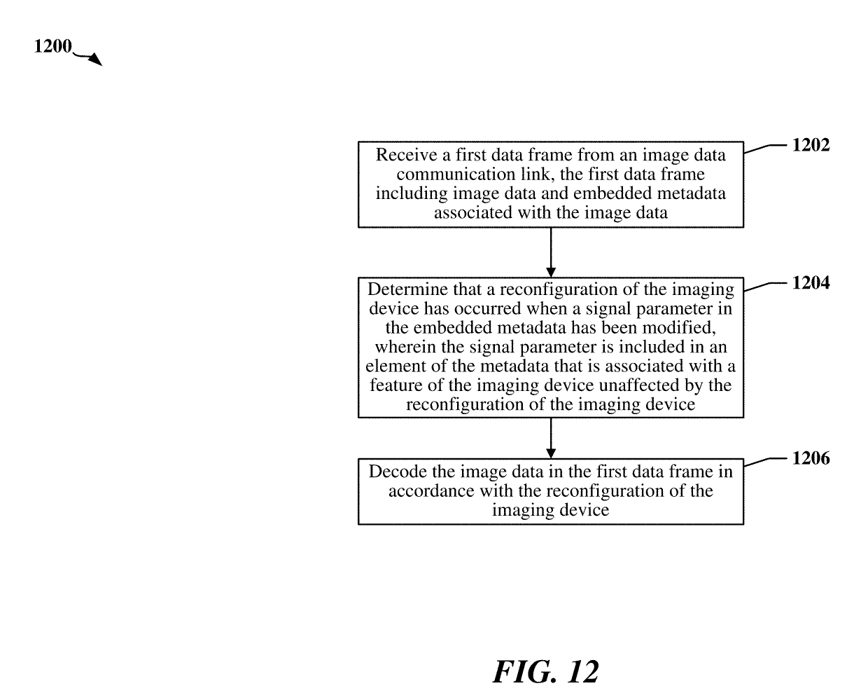

FIG. 12 is a flow chart 1200 of a method for detecting configuration changes in an imaging device. The method may be performed by an application processor or other host processing device coupled to an imaging device or camera device.

At block 1202, the processor may receive a first data frame from an image data communication link, the first data frame includes image data and embedded metadata associated with the image data.

At block 1204, the processor may determine that a reconfiguration of the imaging device has occurred when a signal parameter in the embedded metadata has been modified. The signal parameter may be included in an element of the metadata that is associated with a feature of the imaging device unaffected by the reconfiguration of the imaging device. Reconfiguration of the imaging device may also be determined to have occurred when an unused parameter in the embedded metadata has a value different from a value of the unused parameter in metadata transmitted with a preceding data frame.

At block 1206, the processor may decode the image data in the first data frame in accordance with the reconfiguration of the imaging device.

In some examples, the processor may transmit a configuration command to the imaging device over a control data bus, and parse embedded metadata in one or more data frames received after transmitting the configuration command to determine when the signal parameter has been modified by the image sensor, or has been propagated to a streamed image frame.

In one example, the processor may determine that the signal parameter has been modified when a preconfigured signal value is stored in a parameter in the element of the metadata that is associated with the feature of the imaging device unaffected by the reconfiguration of the imaging device.

In one example, content of the embedded metadata may be defined by a camera command set specification. The embedded metadata may be modified when a signal value is stored in a parameter in the embedded metadata that is undefined by the camera command set specification. The embedded metadata may be modified when a signal value is stored in a parameter in the embedded metadata related to flash control or fine integration time.

In one example, the image data communication link comprises one or more lanes that carry a differentially-encoded data signal and a clock lane that carries a differentially encoded clock signal.

In another example, data is encoded in symbols transmitted on the image data communication link, each symbol defining signaling state of a three-phase signal that is transmitted in different phases on each wire of a three-wire link, and wherein clock information is encoded in transitions between the symbols transmitted on the image data communication link.

In some examples, the processor may transmit one or more commands to the imaging device to cause the reconfiguration of the imaging device. The one or more commands may cause the signal parameter to be stored in the element of the metadata. A controller in the imaging device or associated with the imaging device may store the signal parameter in the element of the metadata. The processor may calculate a value for the signal parameter based on current content of the element of the metadata. The element of the metadata comprises an unused parameter in the embedded metadata. The content of the embedded metadata may be defined by a camera command set specification. In one example, the element of the metadata may be a parameter in the embedded metadata that is undefined by the camera command set specification.

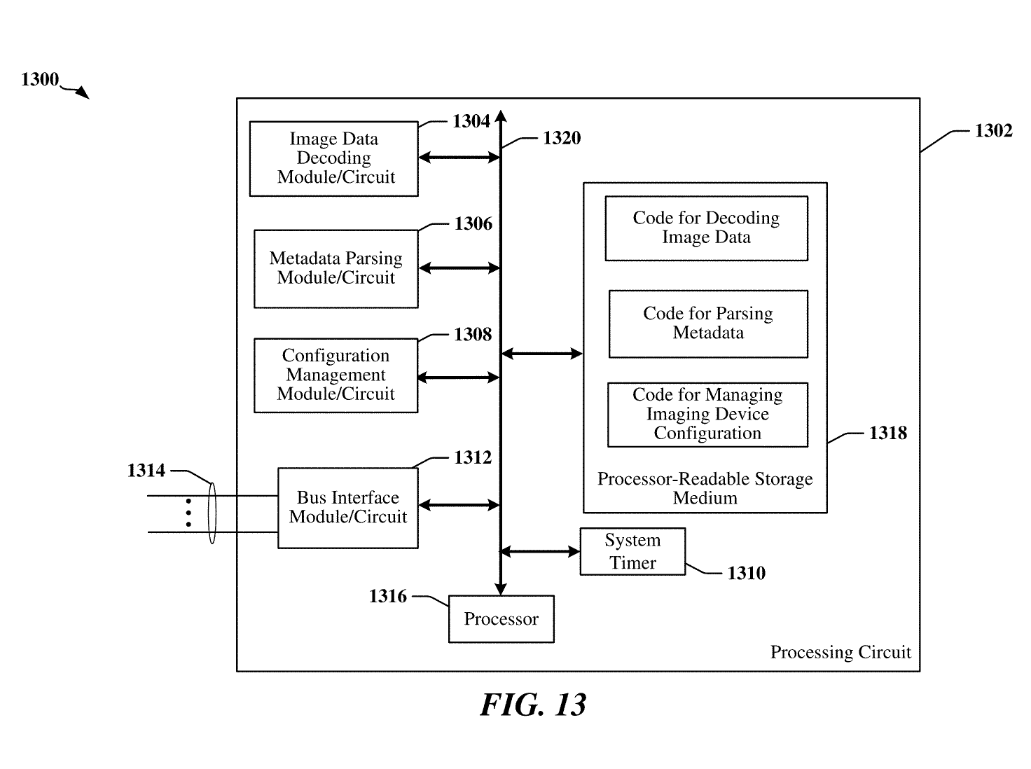

FIG. 13 is a diagram illustrating an example of a hardware implementation for an apparatus 1300 employing a processing circuit 1302. The processing circuit typically has a processor 1316 that may include one or more of a microprocessor, microcontroller, digital signal processor, a sequencer and a state machine. The processing circuit 1302 may be implemented with a bus architecture, represented generally by the bus 1320. The bus 1320 may include any number of interconnecting buses and bridges depending on the specific application of the processing circuit 1302 and the overall design constraints. The bus 1320 links together various circuits including one or more processors and/or hardware modules, represented by the processor 1316, the modules or circuits 1304, 1306, 1308, line interface circuits 1312 configurable to communicate over connectors or wires of a data communication link 1314 and the computer-readable storage medium 1318. The bus 1320 may also link various other circuits such as timing sources, peripherals, voltage regulators, and power management circuits, which are well known in the art, and therefore, will not be described any further.

The processor 1316 is responsible for general processing, including the execution of software stored on the computer-readable storage medium 1318. The software, when executed by the processor 1316, causes the processing circuit 1302 to perform the various functions described supra for any particular apparatus. The computer-readable storage medium may also be used for storing data that is manipulated by the processor 1316 when executing software, including data decoded from symbols transmitted over the data communication link 1314, which may be configured to include data lanes and clock lanes. The processing circuit 1302 further includes at least one of the modules 1304, 1306, and 1308. The modules 1304, 1306, and 1308 may be software modules running in the processor 1316, resident/stored in the computer-readable storage medium 1318, one or more hardware modules coupled to the processor 1316, or some combination thereof. The modules 1304, 1306, and/or 1308 may include microcontroller instructions, state machine configuration parameters, or some combination thereof.

In one configuration, the apparatus 1300 includes a module and/or circuit 1312 that is configured to receive a first data frame from the data communication link 1314, the first data frame including image data and embedded metadata associated with the image data, a module and/or circuit 1306 configured to determine that a reconfiguration of the imaging device has occurred when a signal parameter in the embedded metadata has been modified, where the signal parameter is included in an element of the metadata that is associated with a feature of the imaging device unaffected by the reconfiguration of the imaging device, and a module and/or circuit 1304 configured to decode the image data in the first data frame in accordance with the reconfiguration of the imaging device.

The apparatus 1300 may include a module and/or circuit 1308 configured to transmit a configuration command to the imaging device over a control data bus, where the module and/or circuit 1306 configured to determine that a reconfiguration of the imaging device may be configured to parse embedded metadata in one or more data frames received after the configuration command has been transmitted to determine when the signal parameter has been modified.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for detecting configuration changes in an imaging device, comprising:
receiving a first data frame from an image data communication link, the first data frame including image data and embedded metadata associated with the image data;
determining that a reconfiguration of the imaging device has occurred when a signal parameter in the embedded metadata has been modified, wherein the signal parameter is included in an element of the metadata that is associated with a feature of the imaging device unaffected by the reconfiguration of the imaging device; and
decoding the image data in the first data frame in accordance with the reconfiguration of the imaging device.

2. The method of claim 1, further comprising:
transmitting a configuration command to the imaging device over a control data bus, wherein the configuration command causes the reconfiguration of the imaging device; and
parsing embedded metadata associated with one or more data frames received after transmitting the configuration command to determine when the signal parameter has been modified.

3. The method of claim 1, further comprising:
transmitting one or more commands to the imaging device to cause the reconfiguration of the imaging device,
wherein the one or more commands cause the signal parameter to be stored in the element of the metadata.

4. The method of claim 3, further comprising:
calculating a value for the signal parameter based on current content of the element of the metadata.

5. The method of claim 3, wherein the element of the metadata comprises an unused parameter in the embedded metadata.

6. The method of claim 3, wherein content of the embedded metadata is defined by a camera command set specification, and wherein the element of the metadata comprises a parameter in the embedded metadata that is undefined by the camera command set specification.

7. The method of claim 1, further comprising:
determining that the signal parameter has been modified when a preconfigured signal value is stored in a parameter in the element of the metadata.

8. The method of claim 1, wherein the reconfiguration of the imaging device is determined to have occurred when an unused parameter in the embedded metadata has a value different from a value of the unused parameter in metadata transmitted with a preceding data frame.

9. The method of claim 1, wherein content of the embedded metadata is defined by a camera command set specification, and wherein the embedded metadata is modified when a signal value is stored in a parameter in the embedded metadata that is undefined by the camera command set specification.

10. The method of claim 1, wherein content of the embedded metadata is defined by a camera command set specification, and wherein the embedded metadata is modified when a signal value is stored in a parameter in the embedded metadata related to flash control or fine integration time.

11. The method of claim 1, wherein the image data communication link comprises one or more lanes that carry a differentially-encoded data signal and a clock lane that carries a differentially encoded clock signal.

12. The method of claim 1, wherein data is encoded in symbols transmitted on the image data communication link, each symbol defining signaling state of a three-phase signal that is transmitted in different phases on each wire of a three-wire link, and wherein clock information is encoded in transitions between the symbols transmitted on the image data communication link.

13. A system comprising:
a control data bus;
an image data link;
an imaging device coupled to the control data bus and to the image data link; and
an application processor coupled to the control data bus and to the image data link, wherein the application processor is configured to:
receive a first data frame from an image data communication link, the first data frame including image data and embedded metadata associated with the image data;
determine that a reconfiguration of the imaging device has occurred when a signal parameter in the embedded metadata has been modified, wherein the signal parameter is included in an element of the metadata that is associated with a feature of the imaging device unaffected by the reconfiguration of the imaging device; and
decode the image data in the first data frame in accordance with the reconfiguration of the imaging device.

14. The system of claim 13, wherein the application processor is configured to:
transmit a configuration command to the imaging device over the control data bus, wherein the configuration command causes the reconfiguration of the imaging device; and
parse embedded metadata associated with one or more data frames received after transmitting the configuration command to determine when the signal parameter has been modified.

15. The system of claim 13, wherein the application processor is configured to:
transmit one or more commands to the imaging device to cause the reconfiguration of the imaging device,
wherein the one or more commands cause the signal parameter to be stored in the element of the metadata.

16. The system of claim 15, wherein the application processor is configured to:
calculate a value for the signal parameter based on current content of the element of the metadata.

17. The system of claim 15, wherein the element of the metadata comprises an unused parameter in the embedded metadata.

18. The system of claim 15, wherein content of the embedded metadata is defined by a camera command set specification, and wherein the element of the metadata comprises a parameter in the embedded metadata that is undefined by the camera command set specification.

19. The system of claim 13, wherein the application processor is configured to:
determine that the signal parameter has been modified when a preconfigured signal value is stored in a parameter in the element of the metadata.

20. The system of claim 13, wherein the reconfiguration of the imaging device is determined to have occurred when an unused parameter in the embedded metadata has a value different from a value of the unused parameter in metadata transmitted with a preceding data frame.

21. The system of claim 13, wherein content of the embedded metadata is defined by a camera command set specification, and wherein the embedded metadata is modified when a signal value is stored in a parameter in the embedded metadata that is undefined by the camera command set specification.

22. The system of claim 13, wherein content of the embedded metadata is defined by a camera command set specification, and wherein the embedded metadata is modified when a signal value is stored in a parameter in the embedded metadata related to flash control or fine integration time.

23. The system of claim 13, wherein the image data communication link comprises one or more lanes that carry a differentially-encoded data signal and a clock lane that carries a differentially encoded clock signal.

24. The system of claim 13, wherein data is encoded in symbols transmitted on the image data communication link, each symbol defining signaling state of a three-phase signal that is transmitted in different phases on each wire of a three-wire link, and wherein clock information is encoded in transitions between the symbols transmitted on the image data communication link.

25. An apparatus comprising:
means for receiving a first data frame from an image data communication link, the first data frame including image data and embedded metadata associated with the image data:
means for determining that a reconfiguration of an imaging device has occurred when a signal parameter in the embedded metadata has been modified, wherein the signal parameter is included in an element of the metadata that is associated with a feature of the imaging device unaffected by the reconfiguration of the imaging device; and
means for decoding the image data in the first data frame in accordance with the reconfiguration of the imaging device.

26. The apparatus of claim 25, further comprising:
means for transmitting a configuration command to the imaging device over a control data bus, wherein the configuration command causes the reconfiguration of the imaging device; and
means for parsing embedded metadata associated with one or more data frames received after transmitting the configuration command to determine when the signal parameter has been modified.

27. The apparatus of claim 25, further comprising:
means for transmitting one or more commands to the imaging device to cause the reconfiguration of the imaging device,
wherein the one or more commands cause the signal parameter to be stored in the element of the metadata.

28. A processor-readable storage medium having one or more instructions which, when executed by at least one processor of a processing circuit, cause the processing circuit to:
receive a first data frame from an image data communication link, the first data frame including image data and embedded metadata associated with the image data;
determine that a reconfiguration of an imaging device has occurred when a signal parameter in the embedded metadata has been modified, wherein the signal parameter is included in an element of the metadata that is associated with a feature of the imaging device unaffected by the reconfiguration of the imaging device; and
decode the image data in the first data frame in accordance with the reconfiguration of the imaging device.

29. The storage medium of claim 28, wherein the one or more instructions cause the processing circuit to:
transmit a configuration command to the imaging device over a control data bus, wherein the configuration command causes the reconfiguration of the imaging device; and
parse embedded metadata associated with one or more data frames received after transmitting the configuration command to determine when the signal parameter has been modified.

30. The storage medium of claim 28, wherein the one or more instructions cause the processing circuit to:
transmit one or more commands to the imaging device to cause the reconfiguration of the imaging device,
wherein the one or more commands cause the signal parameter to be stored in the element of the metadata.
